(19) United States
(12) Patent Application Publication
(10) Pub. No.: US 2015/0381577 A1
(43) Pub. Date: Dec. 31, 2015

(54) SYSTEM FOR, AND METHOD OF, AUTHENTICATING A SUPPLICANT, AND DISTRIBUTING GROUP KEYS TO GROUP MEMBERS, IN A MULTI-HOP WIRELESS COMMUNICATIONS NETWORK WITH ENHANCED SECURITY

(71) Applicant: MOTOROLA SOLUTIONS, LLC., Schaumburg, IL (US)

(72) Inventors: KATRIN REITSMA, Chicago, IL (US); ANTHONY R METKE, Naperville, IL (US)

(21) Appl. No.: 14/320,158

(22) Filed: Jun. 30, 2014

(51) Int. Cl. H04L 29/06; H04L 9/32; H04L 9/14; H04W 12/04

(52) U.S. Cl. CPC H04L 63/0428; H04W 12/04; H04L 9/3273; H04L 9/14; H04L 2209/24; H04L 2209/80

(57) ABSTRACT

An authenticator receives an authentication request from a supplicant requesting access to a wireless multi-hop network, and forwards the authentication request to one or more relays operative for relaying the authentication request to an authentication server. The server generates an authenticator key known to the authenticator, generates a supplicant key known to the supplicant, encrypts the supplicant key with the authenticator key, and transmits an authentication success message with the encrypted supplicant key to the authenticator to enable the supplicant to be added to the network without any relay having knowledge of the supplicant key. Encrypted group access keys are also distributed to authenticated members of a network group.

### BACKGROUND OF THE INVENTION

The present invention relates generally to a system for, and a method of, authenticating a supplicant in a multi-hop wireless communications network, as well as distributing group keys to group members in such a network, all with enhanced security.

Many wireless communications networks require a mobile device, hereinafter sometimes referred to as a supplicant, requesting network access, to be reliably authenticated to the network. Some networks, which operated in accordance with the Institute of Electrical and Electronics Engineers (IEEE) 802.1X protocol, used a centralized approach, in which a single infrastructure access point (IAP) communicated with an authentication server (AS) and directly handled all authentication requests from all supplicants desiring network access. This centralized approach, however, was unsatisfactory, because it required all the supplicants to be in wireless range of the IAP. Since some networks cover a relatively large and wide geographical area, and since the IAP is typically a fixed base station having a fixed range, some supplicants were sometimes out of range of the IAP and, therefore, could not readily obtain network access, if at all.

To improve such network access, U.S. Pat. App. Pub. No. 2006/0236377 described a distributed approach, in which, as shown in FIG. 1, the supplicant did not directly communicate with the IAP, but instead, the supplicant communicated with another trusted mobile device, hereinafter sometimes referred to as an authenticator, which, in turn, communicated with the IAP though one or more other mobile devices, hereinafter sometimes referred to as relays. In this distributed approach, the supplicant needed only to be in wireless range of the authenticator, which could be geographically located very far from the IAP due to the intermediate presence of one, and typically many more, of the relays.

Although this distributed approach was satisfactory in creating a multi-hop network that could rapidly scale and grow in terms of wireless coverage to offer secure network access to a large number of mobile devices, some networks required a higher level of security. In typical operation, the supplicant would generate a unique supplicant key; the authenticator would send an authentication request message via the relays and the IAP inbound to the AS; the AS would also generate the supplicant key; the AS would send an authentication response message, with the supplicant key embedded therein, outbound via the IAP and the relays back to the authenticator; and the authenticator would enable the supplicant to be added to the network. However, in this known operation, not only the IAP, but also all the relays knew the supplicant key. One or more of the relays could be untrustworthy. One or more of the relays were vulnerable to hacking attacks to discover the supplicant key, and thereby gain unauthorized network access.

One example of a wireless network requiring enhanced security is a private, secure, and protected, proprietary public safety (PS) network governed by one or more PS agencies, e.g., a local government, or a department, such as a police or a fire department. In an emergency or like incident, PS personnel, such as local or federal police officers, firefighters, paramedics, emergency medical service technicians, disaster relief workers, military rescue personnel, and like first responders, from one or more PS agencies, are typically dispatched to an incident scene in the field to respond to the emergency. Some PS personnel are remote operators who work remotely from the field. The PS personnel typically utilize and operate wireless mobile devices, both handheld and vehicle-supported, while working in, or remotely from, the field. Such PS mobile devices include, for example, land mobile radios (LMRs), such as handheld radios and/or vehicular radios, to support wireless, two-way, voice and data communications, smartphones, laptop computers, tablets, computers, personal digital assistants (PDAs), wearable communications devices, autonomous devices, such as remotely-operated, unmanned aerial vehicles (UAVs) or drones and robots, and like devices, all needing secure authentication before getting access to the PS network, or access to the Internet. It would be unacceptable for such networks to be compromised by an unauthorized user gaining access to the PS network by interrogating the relays and/or the IAP to harvest the supplicant key.

When multiple PS agencies or groups respond to the emergency with such devices that wish to share, and communicate over, the network, it is sometimes desired that the devices belonging to the different agencies be assigned with different levels of trust or assurance. For example, the devices belonging to the local police department may only be trusted to serve as the aforementioned relays, but may not be trusted by federal law enforcement for other communications purposes. It would be desirable for one such group to be assigned without another group having knowledge of the first group's assignment, and it would be unacceptable for such networks to be compromised by a user having an insufficient trust or assurance level.

Accordingly, there is a need to enhance the security of such multi-hop wireless communications networks.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a known multi-hop wireless communications network in accordance with the prior art.

FIG. 2 is a multi-hop wireless communications network to which a supplicant is authenticated with enhanced security in accordance with the system of the present disclosure.

FIG. 3 depicts how certain keys are generated in accordance with the present disclosure.

FIG. 4 is a multi-hop wireless communications network in which group keys are distributed to a group of members with enhanced security in accordance with the present disclosure.

FIG. 5 is a flow chart depicting steps performed in a method of authenticating a supplicant to the network with enhanced security in accordance with the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of the present disclosure relates to a system for authenticating a supplicant, i.e., a wireless mobile device requesting authentication and network access, to a multi-hop wireless communications network. The system includes an authenticator, i.e., a trusted wireless mobile device previously joined in and authenticated to the network, for receiving an authentication request from the supplicant, and for forwarding the authentication request; and at least one relay, and preferably, a plurality of relays, each being another wireless mobile device, for receiving the authentication request from the authenticator, and for relaying the authentication request. The system further includes an authentication server operative for generating an authenticator key, e.g., a service master key (SMK), known to the authenticator, for receiving the relayed authentication request, for generating a supplicant key, e.g., a pairwise master key (PMK), known to the supplicant, for encrypting or wrapping the supplicant key with the authenticator key, and for transmitting an authentication success message with the encrypted supplicant key to the authenticator to enable the supplicant to be added to the network without any relay having knowledge of the supplicant key.

In a preferred embodiment, the authentication request and the authentication success message are received and transmitted in accordance with the extensible authentication protocol (EAP) standard, and the authentication server transmits the authentication success message as EAP packets in which the encrypted supplicant key is embedded. The authenticator is operative for decrypting or unwrapping the encrypted supplicant key with the authenticator key, thereby enabling the supplicant to be added to the network. Since the relays cannot decrypt the encrypted supplicant key and therefore do not know what the supplicant key is, interrogating the relays will not yield the supplicant key, and therefore unauthorized access to the network is reliably prevented, and the network is more secure than heretofore.

Still another aspect of the present disclosure relates to a method of authenticating a supplicant to a multi-hop wireless communications network. The method is performed by generating, with an authentication server, an authenticator key known to an authenticator; receiving an authentication request from the supplicant at the authenticator, and forwarding the authentication request from the authenticator; by receiving the authentication request from the authenticator at one or more relays, and relaying the authentication request from each relay; by receiving the relayed authentication request at the authentication server; by the authentication server generating a supplicant key known to the supplicant; by the authentication server encrypting the supplicant key with the authenticator key; and by the authentication server transmitting an authentication success message with the encrypted supplicant key to the authenticator to enable the supplicant to be added to the network without any relay having knowledge of the supplicant key.

Yet another aspect of the present disclosure relates to a method of distributing group keys to group members in a multi-hop wireless communications network. The method is performed by the authentication server generating a group access key (GAK) indicative of the group members; by the authentication server generating member keys that uniquely identify, and that are known to, the respective group members when they each joined the network, preferably by deriving each member key from a service master key (SMK); by the authentication server encrypting the GAK with each member key to obtain encrypted group access keys; and by the authentication server transmitting a key distribution message for each encrypted group access key to each group member to enable each group member to be added to the network without a non-group member having knowledge of the GAK as well as any member keys.

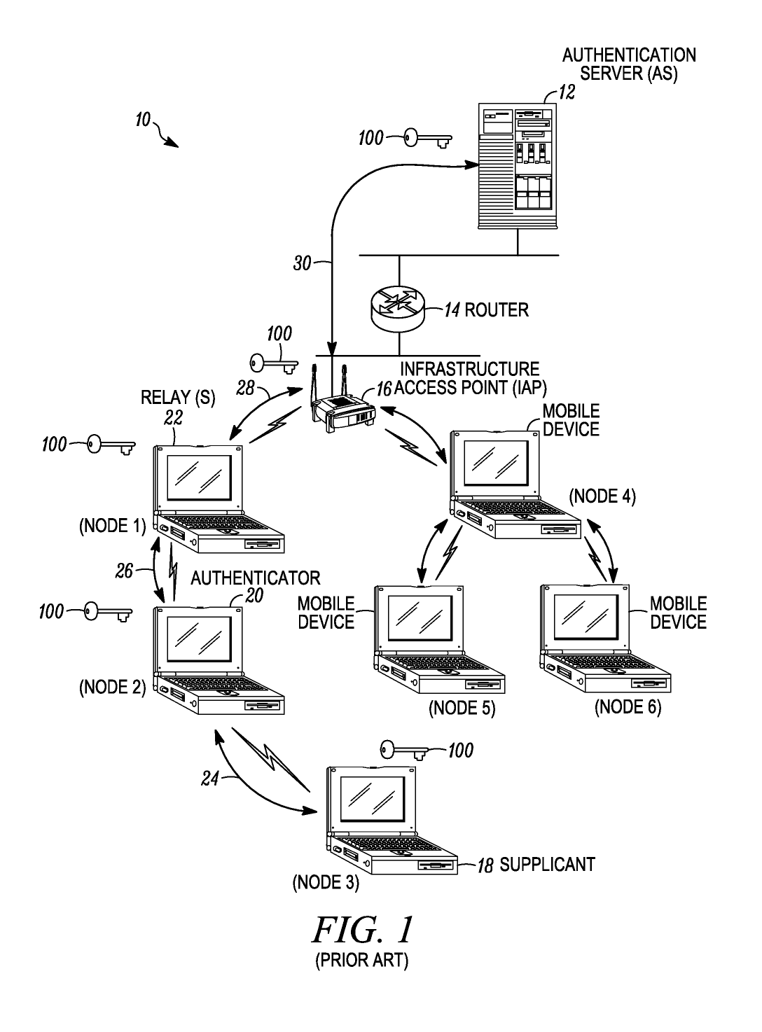

Turning again to FIG. 1, the illustrated, prior art, multi-hop, ad hoc, wireless communications network 10 includes an AS 12 (advantageously, a network computer), a router 14, at least one IAP 16, and a plurality of the mobile devices, also sometimes referred to as nodes 1-6. In an ad hoc network, every node that wishes to join the network 10 has to authenticate itself to some other node. This other node must authenticate the joining node and enforce an access control policy for all the nodes that access the network 10 through this other node. This other node is, as mentioned above, referred to as an “authenticator”, when performing these functions. The joining node trying to join the network 10 is, as mentioned above, referred to as the “supplicant”. Over time, a node may transition from being a supplicant to being an authenticator. For example, when a first node is joining the network 10, it picks a second node that is already part of the network 10 through which to join the network. During the joining process, the first node is known as the supplicant, and the second node is known as the authenticator. If later, a third node attempts to join the network 10 through the first node, then the third node assumes the role of the supplicant, while the first node fulfills the role of the authenticator. The authenticator is also sometimes referred to as a parent node, and the node acting as the supplicant is also sometimes referred to as a child node.

As illustrated in FIG. 1 for purposes of discussion, node 3 has been designated as the current supplicant 18; node 2 has been designated as the current authenticator 20; and node 1 has been designated as one or more of the current relays. In the configuration of FIG. 1, nodes 1 and 4 are each one hop from the IAP 16; nodes 2, 5 and 6 are each two hops from the IAP 16; and node 3 is three hops from the IAP 16. Each node has been illustrated in FIG. 1 as a laptop computer for convenience only, since, as mentioned above, each mobile device can be an LMR, both handheld and/or vehicular-supported, a smartphone, a tablet, a computer, a PDA, a wearable communications device, an autonomous device, such as a remotely-operated, unmanned aerial vehicle (UAV) or drone and a robot, or a like mobile communications device.

In known operation of FIG. 1 in accordance with the extensible authentication protocol (EAP) standard, the supplicant 18 desiring network access exchanges bi-directional communications with the AS 12 via the authenticator 20, with which it is in wireless range over a wireless link or channel 24, and generates a unique supplicant key 100, e.g., a pairwise master key (PMK), as a result of a successful EAP execution. As one such exchange, for example, the authenticator 20 sends a beacon, and the supplicant 18 acknowledges the beacon. Typically, the acknowledgement of the beacon is simply a standard association request or an authentication request. The authenticator 20 receives the authentication request from the supplicant 18 and, in turn, sends the request via a first one of the relays 22, with which it is in wireless range, over a wireless link or channel 26. The first relay may be in series with a chain of relays, each successive pair of relays being in wireless communication. The last one of the relays 22 relays the request over a wireless link or channel 28 to the IAP 16, with which it is in wireless range. The IAP 16 sends the request over another channel 30, preferably a wired channel, inbound to the AS 12. The IAP 16 has access to the backhaul network in which the AS 12 resides.

In other words, when the authenticator 20 receives an EAP packet from the supplicant 18, the authenticator 20 forwards the EAP packet to its parent (i.e., the first relay 22 that previously served as an authenticator when the authenticator 20 joined the network). In this way, the EAP packets traverse a path from the supplicant 18 to the AS 12 through a chain of trusted authenticators, who have each previously authenticated their immediate parent or child nodes.

As a result of the exchange of EAP messages with the supplicant 18 via the authenticator 20 and the relays 22, the AS 12 also generates the supplicant key 100. The AS 12 sends an authentication success message, with the supplicant key 100 embedded therein, outbound via the IAP 16 and the relays 22 back to the authenticator 20 over channels 30, 28 and 26. The authenticator 20 executes a challenge-response type protocol, e.g., a four-way handshake, with the supplicant 18 over channel 24, after which the supplicant 18 is authenticated and granted network access. The supplicant 18 does not transmit the supplicant key 100 to the authenticator 20, but instead, proves its knowledge of the supplicant key 100 to the authenticator 20 via the challenge-response type protocol.

However, in this known operation, not only the IAP 16, but also all the relays 22 know the supplicant key 100. One or more of the relays 22 could be untrustworthy. One or more of the relays 22, and even the IAP 16, are each vulnerable to hacking attacks to discover the supplicant key 100 and thereby gain unauthorized network access. Aside from hacking attacks, as mentioned above, there are times when different groups of network users or members all wish full network access, but one group does not wish another of the other groups to have such full network access. For example, as described above for the case of multiple groups of first responders responding to an emergency, a federal law enforcement group may not wish a local police officer group, or perhaps a firefighter group, to have full access to the PS network. For example, the federal law enforcement group might not object if the devices of the local police officer/firefighter group served as relays, but might object for such devices to have full access to the communications of the federal law enforcement group. It may therefore be desired to assign the devices of these different groups with different levels of trust or assurance.

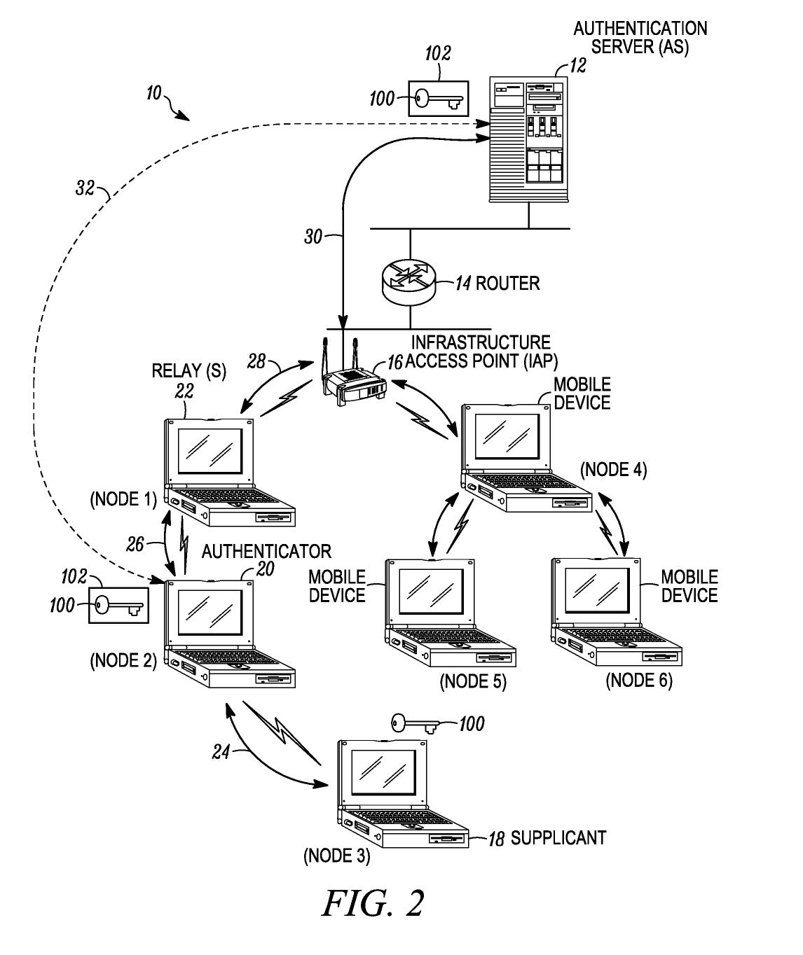

Turning now to FIG. 2, like reference numerals have been used to identify like parts as described in FIG. 1, and hence, their structure and operation need not be repeated, except to say that one aspect of the system and method of the present invention enhances network security by preventing the relays 22, and optionally, the IAP 16 from knowing the supplicant key 100. To this purpose, the AS 12 also generates and stores an authenticator key, e.g., a service master key (SMK), known to the authenticator 20. The authenticator key is preferably generated by the authenticator 20 and by the AS 12 at an earlier time when the authenticator 20 joined, and was authenticated to, the network 10. The AS 12 encrypts or wraps the supplicant key 100 with the authenticator key already generated by, and previously known to, the authenticator 20. The encrypted supplicant key is identified in FIG. 2 by a box 102, thereby indicating that the encrypted supplicant key 102 is protected.

As before, the AS 12 sends an authentication success message, but this time with the encrypted supplicant key 102 embedded therein, outbound via the IAP 16 and the relays 22 back to the authenticator 20 over channels 30, 28 and 26. The authenticator 20 decrypts the encrypted supplicant key 102 and executes a challenge-response type protocol, e.g., a four-way handshake, with the supplicant 18 over channel 24, after which the supplicant 18 is authenticated and granted network access.

In other words, each node that serves as a supplicant generates its own individual supplicant key 100 and individual authenticator key, and both these keys are known only to the respective node and the AS 12. The AS 12 encrypts or wraps the supplicant key 100 with the authenticator key already generated by, and previously known to, the authenticator 20.

In contrast to the known operation of the prior art, none of the relays 22, and optionally the IAP 16, knows the supplicant key 100. None of the relays 22 has knowledge of the authenticator key previously generated by the authenticator 20 and, hence, cannot decrypt or unwrap the encrypted supplicant key 102. This situation is depicted in FIG. 2 by a virtual, end-to-end, protected tunnel or encrypted channel 32 between the AS 12 and the authenticator 20. The tunnel 32 is a protected link with a security association (SA), i.e., a protected channel for conveying traffic with encryption between two nodes or endpoints.

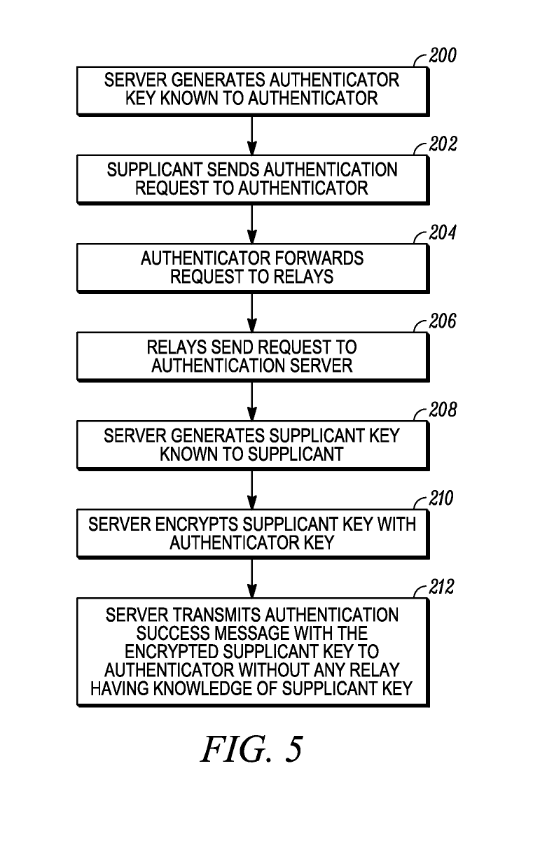

The method of this invention is depicted in the flow chart of FIG. 5. In step 200, the AS 12 generates and stores the authenticator key when the authenticator 20 joined the network 10, i.e., when the authenticator 20 was acting as a supplicant. In step 202, the supplicant 18 sends the authentication request to the authenticator 20. In step 204, the authenticator 20 forwards the request to the relays 22. In step 206, the relays 22 forward the request to the AS 12. In step 208, the AS 12 generates the supplicant key 100. In step 210, the AS 12 encrypts or wraps the supplicant key with the stored authenticator key. In step 212, the AS 12 transmits an authentication success message with the encrypted supplicant key 102 to the authenticator 20.

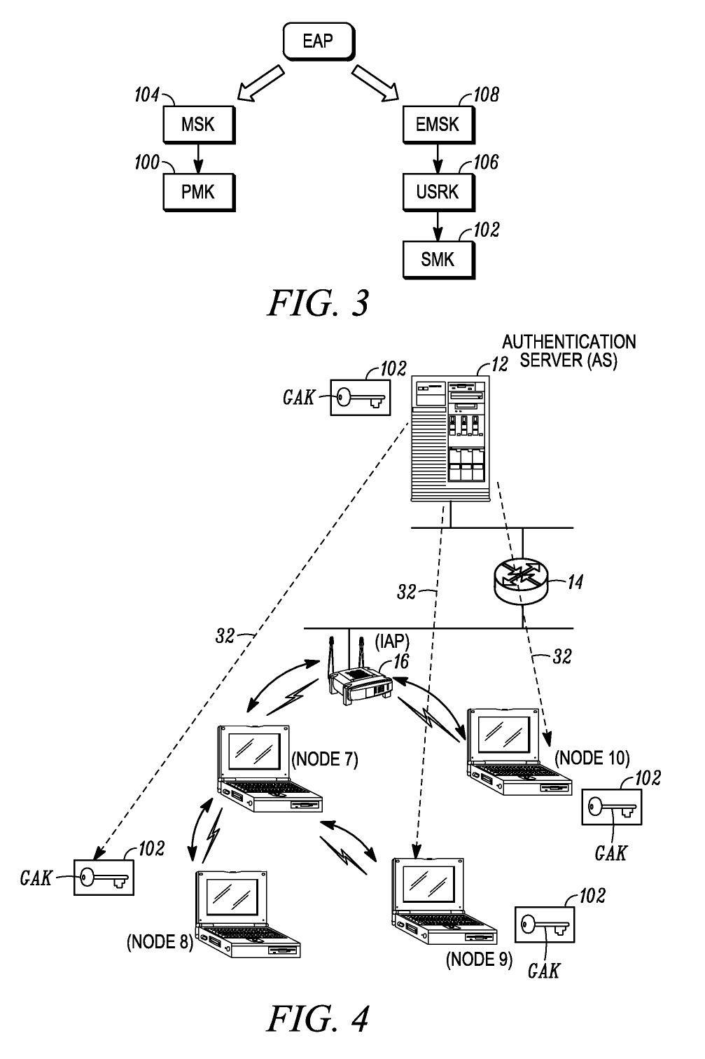

Advantageously, as shown in FIG. 3, in accordance with the EAP standard, the AS 12 generates the supplicant key as a pairwise master key (PMK) 100 from an exportable, master secret key (MSK) 104, and also generates the authenticator key as a service master key (SMK) 102 from a non-exportable, usage specific root key (USRK) 106 and, in turn, from a non-exportable, extended master secret key (EMSK) 108. The MSK 104 and the EMSK 108 may be generated in accordance with Request For Comments (RFC) 4017 of the EAP standard, and the USRK 106 is generated from the EMSK 108 in accordance with RFC 5295 of the EAP standard. The term “exportable” is intended to mean that the key can be transferred to another entity; thus, the AS 12 can generate the PMK 100 and transfer it to the authenticator 20. However, the non-exportable EMSK 108 and all keys derived from it (USRK 106, SMK 102) cannot be transferred from the AS 12 to any other entity.

The MSK 104 and the EMSK 108 are preferably established by running a key-generating cryptographic function at the AS 12 and the supplicant 18. In one embodiment, the key-generating function leverages public key cryptography, and the key-generating function is either the function commonly known as Diffie Hellman, or Elliptic Curve Diffie Hellman. Typically, the EAP protocol is used to transport parameters, such as public keys, random values, and signed data, between the AS 12 and the supplicant 18. These parameters are used by the key-generating cryptographic function to ensure that both the AS 12 and the supplicant 18 generate the same value for the MSK 104 and the EMSK 108. In some cases, the key-generating function may generate the key at one party (either the AS 12 or the supplicant 18) and transfer the key, protected by public key cryptography, to the other party. In any case, the key generated by the key-generating function may be the MSK 104, the EMSK 108, or some other key from which the MSK 104 or the EMSK 108 are derived.

There are various methods by which the SMK 102 can be derived such that only the AS 12 and the supplicant 18 can derive the keys. In a first method, the SMK 102 is calculated by generating a hash of a key known to both the AS 12 and the supplicant 18, such as the URSK 106, combined with other parameters known to both the AS 12 and the supplicant 18, such as a predetermined value or string, values commonly known as Nonces provided by both parties, the addresses of both parties, etc. The hash function may be a standard hash function such as those functions known as secure hash algorithm (SHA)-X or message digest (MD)-X, or the hash function may be any one-way mathematical function. The term “combined” as used above may refer to concatenation, or any bit-for-bit logical operation, such as the well known exclusive-or (XOR) function, or any other mathematical function, or any combination of these functions.

In a second method that is compliant with IEEE 802.11i, the SMK=hash message authentication code (HMAC) SHA-256 (USRK, “SMK key expansion” ∥Min(ASA,ATA)∥Max(ASA,ATA)∥Min(ANonce,SNonce)∥Max(ANonce,SNonce)), wherein:

ASA is the Authentication Server Address,

ATA is the Authenticator Address,

ANonce is a random number selected by the authenticator 20,

SNonce is a random number elected by the AS 12,

the symbol ∥ denotes concatenation, and

the values ASA, ATA, ANonce and SNonce are exchanged during the EAP protocol.

In a third method that is compliant with IETF RFC 5295, the SMK=PRF+(USRK, “SMK key expansion”∥“\0”∥optional data∥length), wherein:

the symbol ∥ denotes concatenation,

the symbol “\0” is a NULL octet (0x00 in hex),

length is a 2-octet unsigned integer in network byte order, and

PRF+ is the default key derivation function (KDF) specified in RFC 5295.

In another aspect of this disclosure, FIG. 4 depicts how encrypted group keys are distributed to different groups of mobile devices in a network. As before, an AS 12, a router 14, and an IAP 16 communicate with a plurality of mobile devices, now designated as nodes 7-10. It will be assumed that a first group of the mobile devices, i.e., nodes 8, 9 and 10 are members of a first group, e.g., a federal law enforcement group, and that node 7 belongs to a different non-member group, e.g., a firefighter group, and further that it is desired to securely grant access to all members of a single group at one time, and, among other things, to assign different trust levels to different groups.

It will be further assumed that each node 7-10 has already joined the network and has already been authenticated. Hence, during the authentication, as before, each node 8, 9 and 10 generates its own individual unique key, i.e., a member or destination key that is derived from the service master key (SMK) 102 and, in addition, the AS 12 also generates and stores each such unique member key (SMK). Furthermore, the AS 12 generates a group access key (GAK), and encrypts or wraps the GAK with each member key to obtain encrypted group access keys 102. The AS 12 sends individual messages, with the encrypted group access keys 102 respectively embedded therein, outbound via the IAP 16 and the non-member node 7 back to each member node 8 and 9, and via the IAP 16 directly to member node 10. Each member node 8, 9 and 10 can decrypt their respective encrypted group access key 102. The non-member node 7, and optionally the IAP 16, cannot decrypt the encrypted group access keys 102. This situation is depicted in FIG. 4 by the aforementioned virtual, end-to-end, protected tunnels 32 between the AS 12 and the member nodes 8, 9 and 10.

Thus, the member keys (SMKs) can be used to enable such protected end-to-end key distributions. In this way, the AS 12 can create different groups, each with different trust levels, for example. Upon receiving the encrypted group access keys, these group members can then use the GAK, or a key derived from the GAK, to re-authenticate to the network, e.g., for seamless handovers when roaming to another access point or location in the field, or fast authentication to another network operated by the AS 12, or fast authentication to another network operated by a second AS that received the member and group keys from the first AS 12.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system for authenticating a supplicant to a multi-hop wireless communications network, comprising:
an authenticator for receiving an authentication request from the supplicant, and for forwarding the authentication request;
at least one relay for receiving the authentication request from the authenticator, and for relaying the authentication request; and
an authentication server for generating an authenticator key known to the authenticator, for receiving the relayed authentication request, for generating a supplicant key known to the supplicant, for encrypting the supplicant key with the authenticator key, and for transmitting an authentication success message with the encrypted supplicant key to the authenticator to enable the supplicant to be added to the network without the at least one relay having knowledge of the supplicant key.

2. The system of claim 1, wherein the authentication request and the authentication success message are received and transmitted in accordance with the extensible authentication protocol (EAP) standard, and wherein the authentication server transmits the authentication success message as EAP packets in which the encrypted supplicant key is embedded.

3. The system of claim 1, wherein the authenticator is operative for decrypting the encrypted supplicant key with the authenticator key.

4. The system of claim 1, wherein the authenticator and the supplicant communicate with each other using a challenge-response protocol over a wireless channel, and wherein the authenticator and the at least one relay communicate with each other over another wireless channel, and wherein the authenticator and the authentication server communicate with each other over a virtual, end-to-end, protected tunnel such that the encrypted supplicant key is relayed without decryption by the at least one relay.

5. The system of claim 1, and an infrastructure access point (IAP) operatively connected between the authentication server and the at least one relay, wherein the IAP communicates with the at least one relay over a wireless channel, and wherein the authentication server transmits the authentication success message with the encrypted supplicant key to the authenticator to enable the supplicant to be added to the network without the IAP having knowledge of the supplicant key.

6. The system of claim 1, wherein the authenticator, the supplicant, and the at least one relay are wireless mobile devices.

7. The system of claim 2, wherein the authentication server generates the supplicant key as a pairwise master key (PMK) from an exportable, master secret key (MSK); and wherein the authentication server generates the authenticator key as a service master key (SMK) from a non-exportable, usage specific root key (USRK) and, in turn, from a non-exportable, extended master secret key (EMSK).

8. A method of authenticating a supplicant to a multi-hop wireless communications network, comprising:
generating, by an authentication server, an authenticator key known to an authenticator;
receiving an authentication request from the supplicant at the authenticator, and forwarding the authentication request from the authenticator;
receiving the authentication request from the authenticator at at least one relay, and relaying the authentication request from the at least one relay;
receiving the relayed authentication request at the authentication server;
the authentication server generating a supplicant key known to the supplicant;
the authentication server encrypting the supplicant key with the authenticator key; and
the authentication server transmitting an authentication success message with the encrypted supplicant key to the authenticator to enable the supplicant to be added to the network without the at least one relay having knowledge of the supplicant key.

9. The method of claim 8, wherein the authentication request and the authentication success message are received and transmitted in accordance with the extensible authentication protocol (EAP) standard, and wherein the transmitting of the authentication success message is performed by transmitting the authentication success message as EAP packets in which the encrypted supplicant key is embedded.

10. The method of claim 8, and decrypting the encrypted supplicant key with the authenticator key by the authenticator.

11. The method of claim 8, wherein communication between the authenticator and the supplicant is performed using a challenge-response protocol over a wireless channel, and wherein communication between the authenticator and the at least one relay is performed over another wireless channel, and wherein direct communication between the authenticator and the authentication server is performed over a virtual, end-to-end, protected tunnel such that the encrypted supplicant key is relayed without decryption by the at least one relay.

12. The method of claim 8, and operatively connecting an infrastructure access point (IAP) between the authentication server and the at least one relay, wherein communication between the IAP and the at least one relay is performed over a wireless channel, and wherein the transmitting of the authentication success message is performed by transmitting the authentication success message with the encrypted supplicant key to the authenticator to enable the supplicant to be added to the network without the IAP having knowledge of the supplicant key.

13. The method of claim 8, and configuring the authenticator, the supplicant, and the at least one relay as wireless mobile devices.

14. The method of claim 9, wherein the supplicant key is generated as a pairwise master key (PMK) from an exportable, master secret key (MSK); and wherein the authenticator key is generated as a service master key (SMK) from a non-exportable, usage specific root key (USRK) and, in turn, from a non-exportable, extended master secret key (EMSK).

15. A method of distributing group keys to group members in a multi-hop wireless communications network, comprising:
the authentication server generating a group access key indicative of the group members;
the authentication server generating member keys known to the group members when they joined the network, each member key uniquely identifying a respective group member;
the authentication server encrypting the group access key with each member key to obtain encrypted group access keys; and
the authentication server transmitting a key distribution message for each encrypted group access key to each group member to enable each group member to be added to the network without a non-group member having knowledge of the group access key and any member key.

16. The method of claim 15, and deriving each member key from a service master key (SMK).

17. The method of claim 15, and using the group access key for rapid re-authentication to the network.

18. The method of claim 15, and using the group access key for rapid authentication to another network operated by another authentication server that has access to the group access key stored by the first-mentioned authentication server.
